(19) United States
(12) Patent Application Publication
(10) Pub. No.: US 2025/0341962 A1
(43) Pub. Date: Nov. 6, 2025

(54) BLOCK SET GROUPING POLICY IN A ZONED NAMESPACE MEMORY SUB-SYSTEM

(71) Applicant: Micron Technology, Inc., Boise, ID (US)

(72) Inventors: Juane Li, Milpitas, CA (US); Fangfang Zhu, San Jose, CA (US)

(21) Appl. No.: 19/198,771

(22) Filed: May 5, 2025

Related U.S. Application Data
(60) Provisional application No. 63/643,148, filed on May 6, 2024.

(51) Int. Cl. G06F 3/06

(52) U.S. Cl. CPC G06F 3/0604; G06F 3/064; G06F 3/0679

(57) ABSTRACT

A memory device comprises multiple planes and each plane comprises multiple blocks. A processing device coupled to the memory device identifies good blocks in each plane of the memory device. The processing device generates multiple block sets by grouping the good blocks. Each block set comprises two blocks. The processing device generates a block set by grouping a first block from a first plane with a second block from a second plane.

### PRIORITY APPLICATION

This application claims the benefit of priority to U.S. Provisional Application Ser. No. 63/643,148, filed May 6, 2024, which is incorporated herein by reference in its entirety.

### TECHNICAL FIELD

Embodiments of the disclosure relate generally to memory sub-systems and, more specifically, to block set grouping policies in a zoned namespace (ZNS) memory sub-system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment that includes a memory sub-system, in accordance with some embodiments of the present disclosure.

FIG. 2 is a conceptual diagram illustrating interactions among components in the memory sub-system in performing a method for generating block sets for a memory device in a memory sub-system, in accordance with some embodiments of the present disclosure.

FIGS. 3-5 are flow diagrams illustrating an example method for generating block sets for a memory device in a memory sub-system, in accordance with some embodiments of the present disclosure.

FIG. 6 is a block diagram of an example computer system in which embodiments of the present disclosure may operate.

### DETAILED DESCRIPTION

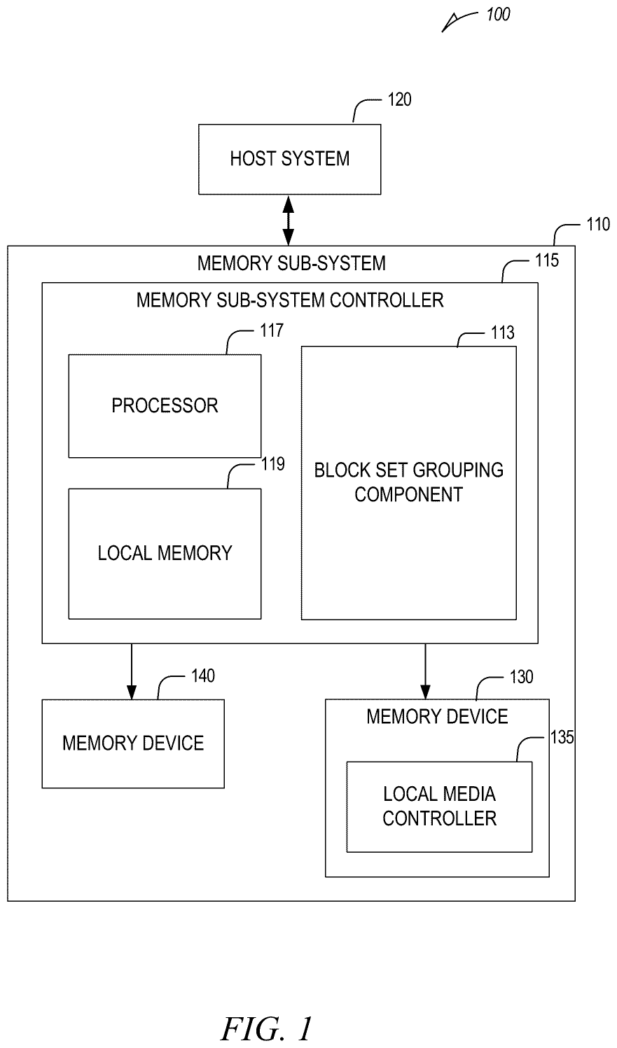

Aspects of the present disclosure are directed to block set grouping policies for generating block sets in a zoned-namespace (ZNS) memory sub-system. In an example, the computing sub-system is a memory sub-system. A memory sub-system can be or include a memory device (e.g., SSD), a memory module, or a combination of a memory device and memory module. Examples of memory devices and memory modules are described below in conjunction with FIG. 1. In general, a host system can utilize a memory sub-system that includes one or more components, such as memory devices that store data. For example, the host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. Other examples of non-volatile memory devices are described below in conjunction with FIG. 1. A NAND memory device can include multiple NAND dies. Each die may include one or more planes and each plane includes multiple blocks. Each block includes an array that includes pages (rows) and strings (columns). A string includes a plurality of memory cells connected in a series. A memory cell (“cell”) is an electronic circuit that stores information. Depending on the cell type, a cell can store one or more bits of binary information and have various logic states that correlate to the number of bits being stored. The logic states can be represented by binary values, such as “0” and “1,” or combinations of such values.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. For some types of memory devices (e.g., NAND), memory cells can be grouped into an erase unit, such as a block. Data can be written to a block, page-by-page. Data can be erased at a block level. However, portions of a block cannot be erased.

A bad block (also referred to herein as “invalid block”) refers to a block that is no longer reliable for storing or retrieving data, for example, due to a defect or due to wear, and may incorrectly store bit values. NAND memory devices can have factory bad blocks (e.g., blocks with a manufacturing defect). The number and location of these bad blocks can vary across dies and planes. Valid blocks in memory devices (the blocks that are not bad blocks) are referred to herein as “good blocks.”

A Zoned Namespace (ZNS) system is a type of storage architecture used in memory sub-systems that is designed to better align with the characteristics of NAND flash memory and to improve the efficiency of storage management. In a ZNS system, the storage space is divided into zones. Each zone is a contiguous range of logical block addresses (LBAs) that is managed as a single unit. Zones are the basic units of storage management in a ZNS memory sub-system. Each zone is written sequentially, which means that new data can only be appended to the end of the current write pointer within a zone. This sequential write mechanism is in line with the way NAND memory operates, as it avoids the overhead associated with out-of-place updates and garbage collection. Each zone has an associated state machine with a set of states that define its operational characteristics. Common zone states include empty, implicitly opened, explicitly opened, closed, full, read-only, and offline.

Block sets, each of which includes a pair of blocks, are used in ZNS systems to manage the way data is stored and accessed on NAND memory within NAND memory devices. By grouping blocks into block sets, the ZNS system can more effectively manage the aforementioned variation in number and location of factory bad blocks, pairing good blocks together to maximize usable storage capacity and minimize the impact of bad blocks. A memory sub-system controller (also referred to herein simply as a “controller”) manages the logical to physical mapping of data and block sets represent a logical grouping that the controller can manage more easily. For example, this logical grouping simplifies the task of tracking which blocks are in use, which are available for writing, and which need to be erased and recycled.

Aspects of the present disclosure address improved techniques for generating block sets within a ZNS memory sub-system. A block set grouping component of the memory sub-system generates block sets in a manner that balances the trade-off between maximizing drive capacity and minimizing system implementation complexity. The block set grouping component may utilize one of multiple example grouping policies described herein. The multiple example grouping policies offer varying levels of complexity and capacity optimization, allowing for tailored solutions based on system requirements.

In a first example grouping policy referred to as static grouping, the block set grouping component generates block sets based on plane sets that are created by grouping consecutive planes. Consistent with the first example grouping policy, the block set grouping component generates block sets by grouping blocks in plane sets based on physical block numbers. Static grouping is the simplest, as it always groups the same physical block numbers from two fixed planes. This predictability simplifies the mapping logic utilized by the controller.

In a second example grouping policy referred to as dynamic block pair grouping, the block set grouping component generates plane sets by grouping consecutive planes in the same manner as the static grouping policy discussed above. In the dynamic block pair grouping policy, the block set grouping component can generate block sets by grouping blocks within a plane set that do not share the same physical block number. That is, the dynamic block pair grouping policy allows pairing different physical block numbers from two fixed planes, providing more flexibility in forming block sets. By allowing more flexibility in pairing, the dynamic block pair grouping policy can improve drive capacity by utilizing good blocks that would otherwise be wasted in the static grouping policy. The dynamic block pair grouping policy minimizes the waste of good blocks by allowing them to be paired with other good blocks, even if they are not the same physical block number.

In a third example grouping policy referred to as dynamic plane pair grouping, the block set grouping component generates plane sets based on the number of good blocks (or the number of bad blocks) in each plane. More specifically, with dynamic plane pair grouping, the planes with the highest number of good blocks are grouped together and the planes with the lowest number of good blocks are grouped together. As with the dynamic block pair grouping policy, in the dynamic plane pair grouping policy, the block set grouping component can generate block sets by grouping blocks within a plane set that do not share the same physical block number. Because dynamic plane pair grouping groups planes with the highest number of good blocks, dynamic plane pair grouping maximizes the number of good blocks used in block sets. Dynamic plane pair grouping also allows the block set grouping component to adapt to the variability of bad blocks across different planes, dynamically choosing the best pairing to form block sets. By efficiently using good blocks, dynamic plane pair grouping can further increase capacity compared to static and dynamic block pairing policies.

In a fourth example grouping policy referred to as dynamic grouping, the block set grouping component may group two good blocks from any two different planes, rather than grouping two good blocks from the planes of a plane set. As with the dynamic block pair and dynamic plan pair grouping policies, in the dynamic grouping policy, the block set grouping component can generate block sets by grouping blocks that do not share the same physical block number. Dynamic grouping is the most flexible grouping policy, allowing any good blocks to be paired together to form a block set, regardless of their plane or block number. Dynamic grouping offers the potential for the highest drive capacity improvement by ensuring that all good blocks can be utilized. The dynamic grouping policy aims to use up all good blocks from the planes, leaving only the plane with the highest number of good blocks with any remainder, thus minimizing waste.

FIG. 1 illustrates an example computing environment 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a USB interface, a Fibre Channel interface, a Serial Attached SCSI (SAS) interface, and so forth. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface provides physical links with multiple communication lanes (also referred to herein simply as “lanes”) for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as SLCs, multi-level cells (MLCs) (e.g., TLCs, or quad-level cells (QLCs)). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

A memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory device 130.

The memory sub-system 110 also includes a block set grouping component 113 that is responsible generating block sets from blocks of the memory device 130. The manner in which the block set grouping component 113 generates the block sets is based on a grouping policy. Further details regarding the operation of the block set grouping component 113 and example grouping policies are discussed below.

In some embodiments, the memory sub-system controller 115 includes at least a portion of the block set grouping component 113. For example, the memory sub-system controller 115 can include a processor 117 (processing device) configured to execute instructions stored in local memory 119 (e.g., firmware) for performing the operations described herein. In some embodiments, the block set grouping component 113 is part of the host system 120, an application, or an operating system. Further details regarding the block set grouping component 113 are discussed below.

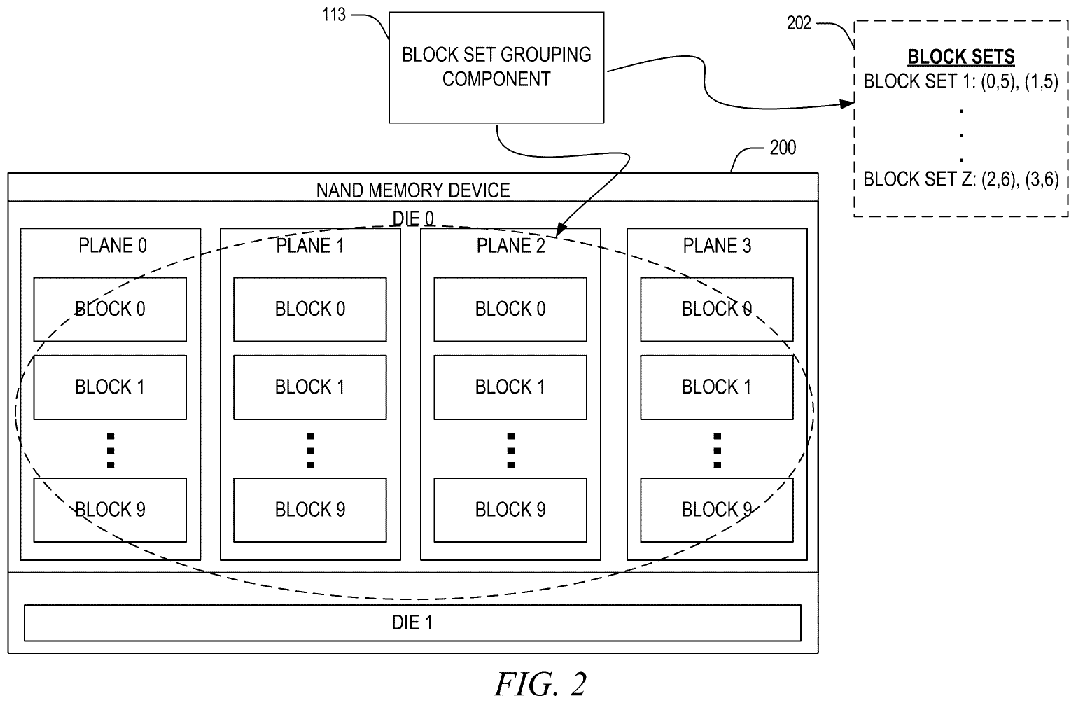

FIG. 2 is conceptual diagram illustrating interactions among components in the memory sub-system in performing a method for generating block sets for a memory device in a memory sub-system, in accordance with some embodiments of the present disclosure. In the example illustrated in FIG. 2, NAND memory device 200 is an example memory device 130.

The NAND memory device 200 includes multiple NAND dies—die 0 and die 1. Each die includes multiple planes. As an example, die 0 comprises planes 0, 1, 2, and 3. Each plane includes multiple blocks. For example, as shown, each plane includes blocks 0-9 (physical block numbers). Each block includes a two- or three-dimensional array that includes pages (rows) and strings (columns). A string includes a plurality of memory cells connected in a series. Each memory cell is used to represent one or more bit values. For example, a single NAND flash cell includes a transistor that stores an electric charge on a memory layer that is isolated by oxide insulating layers above and below. Within each cell, data is stored as the Vt of the transistor. SLC NAND, for example, can store one bit per cell. Other types of memory cells, such as MLCs, TLCs, QLCs, and penta-level cells (PLCs), can store multiple bits per cell.

In this example, each of the four planes includes ten blocks and a portion of blocks in each plane are bad blocks. That is, each plane includes a number of good blocks and a number of bad blocks. The memory sub-system 110 maintains a log (or other suitable data structure) to track block status (e.g., whether a block is a good or bad block). Bad blocks can be marked during manufacturing or detected during system operation. In this example, the breakdown of good blocks and bad blocks (identified by physical block number) is defined by TABLE 1 presented below. The log maintained by the memory sub-system 110 includes or at least indicates the information included in TABLE 1.

TABLE 1

| Plane Number | Bad Blocks | Good Blocks |
|---|---|---|
| 0 | 0, 1, 2, 3, 4 | 5, 6, 7, 8, 9 |
| 1 | 4, 6 | 0, 1, 2, 5, 7, 8, 9 |
| 2 | 2, 4, 5, 7, 8, 9 | 0, 1, 3, 6 |
| 3 | 7 | 0, 1, 2, 3, 4, 5, 6, 8, 9 |

The block set grouping component 113 generates block sets 202 by grouping pairs of good blocks from the die 0. The manner in which the block set grouping component 113 generates the block sets 202 is defined by a grouping policy. The block set grouping component 113 may utilize one of multiple example grouping policies discussed below. In some examples, the grouping policy utilized by the block set grouping component 113 is configurable.

In a first example grouping policy (static grouping), the block set grouping component 113 generates block sets 202 based on plane sets that are created by grouping consecutive planes. For example, plane 0 and plane 1 are consecutive planes and plane 2 and plane 3 are consecutive planes and the block set grouping component 113 generates a first plane set by grouping plane 0 and plane 1 and a second plane set by grouping plane 2 and plane 3. Consistent with the first example grouping policy, the block set grouping component 113 generates block sets 202 by grouping blocks in plane sets based on physical block numbers. That is, the block set grouping component 113 groups blocks in the same plane set that share the same physical block number. Example block sets created using the first example grouping policy are as follows (blocks are referenced by (Plane Number, Block Number)):
Block Set 1: (0, 5) and (1, 5)
Block Set 2: (0, 7) and (1, 7)
Block Set 3: (0, 8) and (1, 8)
Block Set 4: (0, 9) and (1, 9)
Block Set 5: (2, 0) and (3, 0)
Block Set 6: (2, 1) and (3, 1)
Block Set 7: (2, 3) and (3, 3)
Block Set 8: (2, 6) and (3, 6)

In a second example grouping policy (dynamic block pair grouping), the block set grouping component 113 generates plane sets by grouping consecutive planes in the same manner as the first example grouping policy discussed above. In the second example grouping policy, the block set grouping component 113 can generate block sets by grouping blocks within a plane set that do not share the same physical block number. Example block sets created using the second example grouping policy are as follows (blocks are referenced by [Plane Number, Block Number]):
Block Set 1: (0, 5) and (1, 0)
Block Set 2: (0, 6) and (1, 1)
Block Set 3: (0, 7) and (1, 2)
Block Set 4: (0, 8) and (1, 3)
Block Set 5: (0, 9) and (1, 5)
Block Set 6: (2, 0) and (3, 0)
Block Set 7: (2, 1) and (3, 1)
Block Set 8: (2, 3) and (3, 2)
Block Set 9: (2, 6) and (3, 3)

In a third example grouping policy (dynamic plane pair grouping), the block set grouping component 113 generates plane sets based on the number of good blocks (or the number of bad blocks) in each plane. In this example, the block set grouping component 113 generates a first plane set by combining plane 3 (the plane with the highest number of good blocks) with plane 1 (the plane that has the second highest number of good blocks and the block set grouping component 113 generates a second plane set by combining plane 0 (the plane with the second least good blocks) with plane 2 (the plane that has the least good blocks). As with the second example grouping policy, in the third example grouping policy, the block set grouping component 113 can generate block sets by grouping blocks within a plane set that do not share the same physical block number. Example block sets created using the third example grouping policy are as follows (blocks are referenced by [Plane Number, Block Number]):
Block Set 1: (0, 5) and (2, 0)
Block Set 2: (0, 6) and (2, 1)
Block Set 3: (0, 7) and (2, 3)
Block Set 4: (0, 8) and (2, 6)
Block Set 5: (1, 0) and (3, 0)
Block Set 6: (1, 1) and (3, 1)
Block Set 7: (1, 2) and (3, 2)
Block Set 8: (1, 3) and (3, 3)
Block Set 9: (1, 5) and (3, 4)
Block Set 10: (1, 7) and (3, 5)
Block Set 11: (1, 8) and (3, 6)
Block Set 12: (1, 9) and (3, 8)

In a fourth example grouping policy (dynamic grouping), the block set grouping component 113 may group two good blocks from any two different planes, rather than grouping two good blocks from the planes of a plane set. In accordance with the fourth example grouping policy, the generation of the block sets may result in the plane set having the highest number of good blocks having one or more ungrouped blocks (i.e., blocks that are not included in a block set). As with the second and third example grouping policies, in the fourth example grouping policy, the block set grouping component 113 can generate block sets by grouping blocks that do not share the same physical block number. Example block sets created using the fourth example grouping policy are as follows (blocks are referenced by [Plane Number, Block Number]):
Block Set 1: (0, 5) and (2, 0)
Block Set 2: (0, 6) and (2, 1)
Block Set 3: (0, 7) and (2, 3)
Block Set 4: (0, 8) and (2, 6)
Block Set 5: (1, 0) and (3, 0)
Block Set 6: (1, 1) and (3, 1)
Block Set 7: (1, 2) and (3, 2)
Block Set 8: (1, 3) and (3, 3)
Block Set 9: (1, 5) and (3, 4)
Block Set 10: (1, 7) and (3, 5)
Block Set 11: (1, 8) and (3, 6)
Block Set 12: (1, 9) and (3, 8)
Block Set 13: (0, 9) and (3, 9)

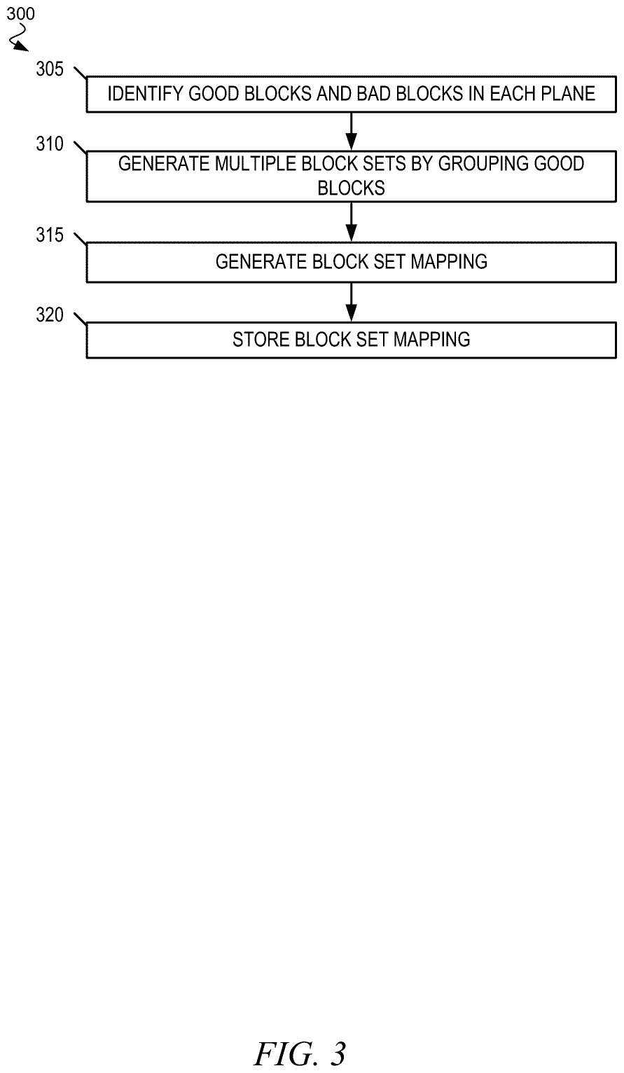

FIGS. 3-5 are flow diagrams illustrating an example method for generating block sets for a memory device in a memory sub-system, in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the block set grouping component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In the example addressed by the description of the method 300 below, a ZNS memory device comprises multiple dies, each die comprises multiple planes, and each plane comprises multiple blocks. Within each plane, blocks are identified by a physical block number (e.g., block 1, block 2, block 3, and so forth). Consistent with this example, the method 300 is performed on a per die basis. That is, only a single die is addressed in the description that follows, but the method 300 is repeated for each die in the memory device.

At operation 305, a processing device identifies good blocks and bad blocks in each plane of a die of the memory device. At operation 310, the processing device generates multiple block sets by grouping the good blocks. Each block set comprises two good blocks selected from different planes. In an example, the processing device generates a block set by grouping a block from the first plane (a “first block”) with a block from the second plane (a “second block”).

At operation 315, which is optional in some examples, the processing device generates a block set mapping. The processing device stores the block set mapping, at operation 320, which is also optional in some examples. The block set mapping identifies each block set and includes identifiers of each block in each block set. In an example, blocks within the block set mapping are identified based on physical block number and the corresponding plane in which the block is located. The processing device can store the block set mapping in local memory (e.g., local memory 119), the memory device (e.g., memory device 130), or another memory device (e.g., memory device 140).

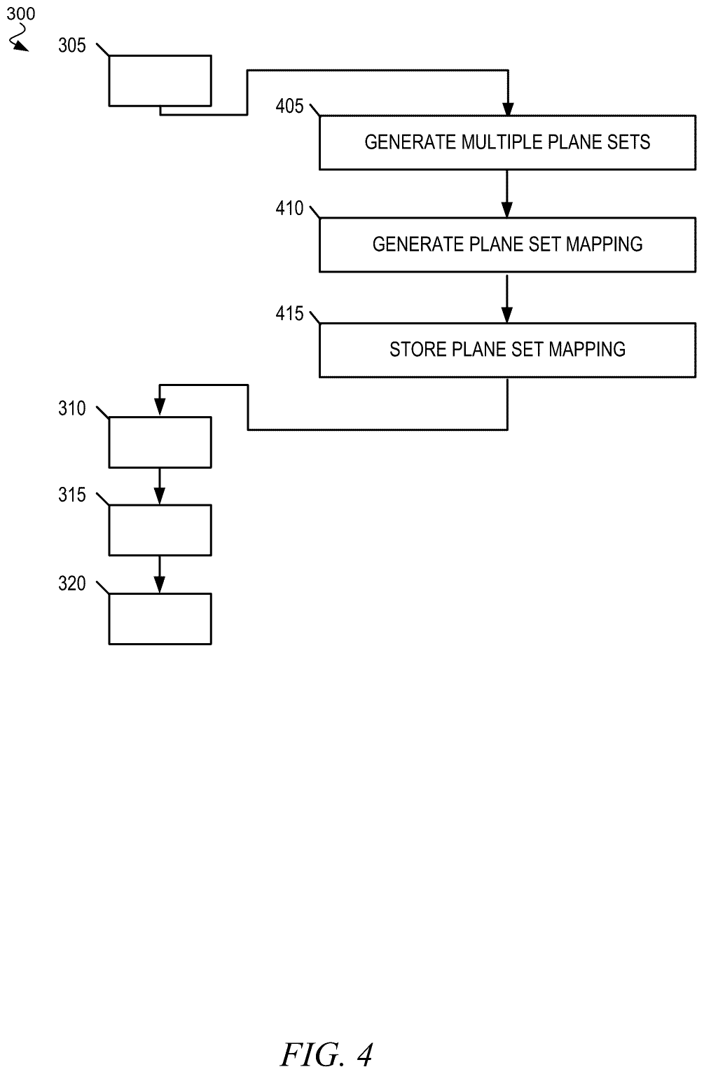

The manner in which the processing device groups blocks to form block sets is based on the grouping policy used by the processing device. In accordance with some example grouping policies, the processing device generates block sets by grouping pairs of blocks within plane sets generated from the multiple planes in the die of the memory device. Accordingly, as shown in FIG. 4, the method 300 may, in some examples, include operations 405, 410, and 415. Consistent with these examples, the operation 405 may be performed prior to operation 310 where the processing device generates the multiple block sets. At operation 405, a processing device generates multiple plane sets from multiple planes in a die of the memory device. Each plane set comprises a pair of planes. In an example, the processing device generates a plane set by grouping a first plane with a second plane.

Consistent with these examples, the operations 410 and 415 may be performed subsequent to the operation 405. The processing generates a mapping of the plane sets, at operation 410, and the processing device stores in the mapping, at operation 415. The mapping identifies the planes (e.g., a pair of planes) in each plane set. The processing device may store the mapping in local memory (e.g., local memory 119 of FIG. 1) or the memory device.

In a first example grouping policy, the processing device generates plane sets by grouping consecutive planes. For example, the processing device groups a first plane with a second plane based on the first plane and the second plane being consecutive planes. Consistent with the first example grouping policy, the processing device generates block sets by grouping blocks in plane sets physical block number. That is, the processing device groups blocks in the same plane set that share the same physical block number. In an example of the first example grouping policy, the processing device generates: a first block set by grouping block 0 from the first plane with block 0 from the second plane; a second block set by grouping block 1 from the first plane with block 1 from the second plane; and a third block set by grouping block 2 from the first plane with block 2 from the second plane. When utilizing the first example grouping policy to generate block sets, the processing device can omit operations 315 and 320 as the plane sets and block sets are fixed so block sets can be easily determined without a block set mapping.

In a second example grouping policy, the processing device generates plane sets by grouping consecutive planes in the same manner as the first example grouping policy discussed above. In the second example grouping policy, the processing device can generate block sets by grouping blocks within a plane set that do not share the same physical block number. In an example of the second example grouping policy, the processing device generates: a first block set by grouping block 0 from the first plane with block 1 from the second plane; a second block set by grouping block 3 from the first plane with block 0 from the second plane; and a third block set by grouping block 2 from the first plane with block 4 from the second plane.

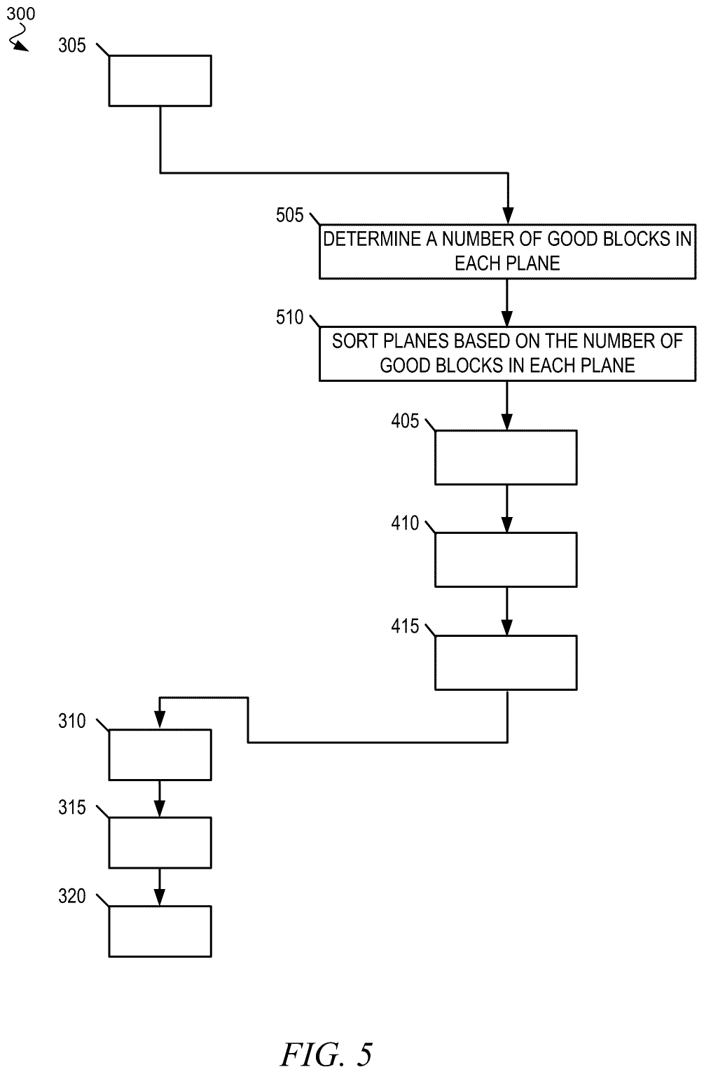

In some example grouping policies, the processing device generates plane sets based on a number of bad blocks in each plane. As such, as shown in FIG. 5, the method 300 may, in some examples, include operations 505 and 510. Consistent with these examples, the operations 505 and 510 are performed prior to or as part of the operation 405 where the processing device generates the plane sets. At operation 505, the processing device determines a number of good blocks in each plane of the die of the memory device. The processing device determines the number of good blocks in each plane by accessing (e.g., from local memory 119) a log that tracks a status of each block in the memory device (e.g., whether a block is a good block or a bad block). At operation 510, the processing device sorts the multiple planes in the die of the memory device based on the number of good blocks in each plane. In alternative examples, the processing device determines a number of bad blocks in each plane and sorts the planes based on the number of bad blocks.

In a third example grouping policy, the processing device generates plane sets based on the number of good blocks (or the number of bad blocks) in each plane. In an example of the third example grouping policy where the die includes four planes, the processing device generates a first plane set by combining a first plane that has the highest number of good blocks (or the lowest number of bad blocks) with a second plane that has the second highest number of good blocks (or the second lowest number of bad blocks) and the processing device generates a second plane set by combining a third plane that has the second least good blocks (or the second most bad blocks) with a fourth plane that has the least good blocks (or the most bad blocks). As with the second example grouping policy, in the third example grouping policy, the processing device can generate block sets by grouping blocks within a plane set that do not share the same physical block number. Furthering the example of the third example grouping policy from above, the processing device generates: a first block set by grouping block 0 from the first plane with block 1 from the second plane; a second block set by grouping block 2 from the first plane with block 0 from a second plane; a third block set by grouping block 2 from the third plane with block 4 from the fourth plane; and a fourth block set by grouping block 0 from the third plane with block 3 from the fourth plane.

In a fourth example grouping policy, the processing device does not generate fixed plane sets in generating block sets. That is, in accordance with the fourth example grouping policy, the processing device may group two good blocks from any two different planes, rather than grouping two good blocks from the planes of a plane set. In accordance with the fourth grouping example, the generation of the block sets may result in the plane set having the highest number of good blocks having one or more ungrouped blocks (i.e., blocks that are not included in a block set). As with the second and third example grouping policies, in the fourth example grouping policy, the processing device can generate block sets by grouping blocks that do not share the same physical block number. In an example of the fourth example grouping policy, the processing device generates: a first block set by grouping block 0 from the first plane with block 1 from the second plane; a second block set by grouping block 2 from the first plane with block 0 from a third plane; and a third block set by grouping block 2 from the second plane with block 4 from a fourth plane.

Described implementations of the subject matter can include one or more features, alone or in combination as illustrated below by way of example.

Example 1. A computing sub-system comprising: a memory device comprising multiple planes, each plane comprising multiple blocks; a processing device coupled to the memory device, the processing device to perform operations comprising: identifying good blocks in each plane of the memory device; and generating multiple block sets by grouping the good blocks, each block set comprising two blocks, the generating of the multiple block sets comprising generating a block set by grouping a first block from a first plane with a second block from a second plane.

Example 2. The computing sub-system of Example 1, wherein the operations comprise: generating multiple plane sets from the multiple planes, the generating of the multiple plane sets including generating a plane set by grouping the first plane with the second plane, wherein the grouping of the first block from the first plane with the second block from the second plane is based on the first plane and the second plane being included in the plane set.

Example 3. The computing sub-system of any one or more of Examples 1 or 2, wherein the operations comprise: generating a mapping of the multiple plane sets, the mapping identifying a pair of planes in each plane set; and storing the mapping of the multiple plane sets.

Example 4. The computing sub-system of any one or more of Examples 1-3, wherein the grouping of the first plane with the second plane is based on the first plane and the second plane being consecutive planes.

Example 5. The computing sub-system of any one or more of Examples 1-4, wherein the grouping of the first block from the first plane with the second block from the second plane is based on the first block and the second block having the same physical block numbers within their respective planes.

Example 6. The computing sub-system of any one or more of Examples 1-5, wherein the operations comprise: determining a number of good blocks in each plane, wherein the grouping of the first plane with the second plane is based on the first plane and the second plane having a highest number of good blocks among the multiple planes.

Example 7.The computing sub-system of any one or more of Examples 1-6, wherein the grouping of the first block from the first plane with the second block from the second plane is based on the first block and the second block having the same physical block numbers within their respective planes.

Example 8. The computing sub-system of any one or more of Examples 1-7, wherein the operations comprise: generating a mapping of the multiple block sets, the mapping identifying a pair of blocks in each block set; and storing the mapping of the multiple block sets.

Example 9.The computing sub-system of any one or more of Examples 1-8, wherein: the first plane has a highest number of good blocks among the multiple planes of the memory device; and the generating of the multiple block sets results in the first plane having one or more ungrouped blocks.

Example 10. A method comprising: identifying, by a processing device, good blocks in each plane of multiple planes of a memory device; and generating, by the processing device, multiple block sets by grouping the good blocks, each block set comprising two blocks, the generating of the multiple block sets comprising generating a block set by grouping a first block from a first plane with a second block from a second plane.

Example 11.The method of Example 10, comprising generating multiple plane sets from the multiple planes, the generating of the multiple plane sets including generating a plane set by grouping the first plane with the second plane, wherein the grouping of the first block from the first plane with the second block from the second plane is based on the first plane and the second plane being included in to the plane set.

Example 12. The method of any one or more of Examples 10 or 11, comprising: generating a mapping of the multiple plane sets, the mapping identifying a pair of planes in each plane set; and storing the mapping of the multiple plane sets.

Example 13. The method of any one or more of Examples 10-12, wherein the grouping of the first plane with the second plane is based on the first plane and the second plane being consecutive planes.

Example 14. The method of any one or more of Examples 10-13, wherein the grouping of the first block from the first plane with the second block from the second plane is based on the first block and the second block having identical physical block numbers within their respective planes.

Example 15. The method of any one or more of Examples 10-14, comprising determining a number of good blocks in each plane, wherein the grouping of the first plane with the second plane is based on the first plane and the second plane having a highest number of good blocks among the multiple planes.

Example 16. The method of any one or more of Examples 10-15, wherein the grouping of the first block from the first plane with the second block from the second plane is based on the first block and the second block having identical physical block numbers within their respective planes.

Example 17. The method of any one or more of Examples 10-16, comprising: generating a mapping of the multiple block sets, the mapping identifying a pair of blocks in each block set; and storing the mapping of the multiple block sets.

Example 18. A computer-readable storage medium comprising instructions that, when executed by a processing device, configure the processing device to perform operations comprising: identifying, by a processing device, good blocks in each plane of multiple planes of a memory device; and generating, by the processing device, multiple block sets by grouping the good blocks, each block set comprising two blocks, the generating of the multiple block sets comprising generating a block set by grouping a first block from a first plane with a second block from a second plane.

Example 19. The computer-readable storage medium of Example 18, wherein the operations comprise: generating multiple plane sets from the multiple planes, the generating of the multiple plane sets including generating a plane set by grouping the first plane with the second plane, wherein the grouping of the first block from the first plane with the second block from the second plane is based on the first plane and the second plane being included to the plane set.

Example 20. The computer-readable storage medium of any one or more of Examples 18 or 19, wherein the operations comprise: determining a number of good blocks in each plane, wherein the grouping of the first plane with the second plane is based on the first plane and the second plane having a highest number of good blocks among the multiple planes, wherein the grouping of the first block from the first plane with the second block from the second plane is based on the first block and the second block having identical physical block numbers within their respective planes.

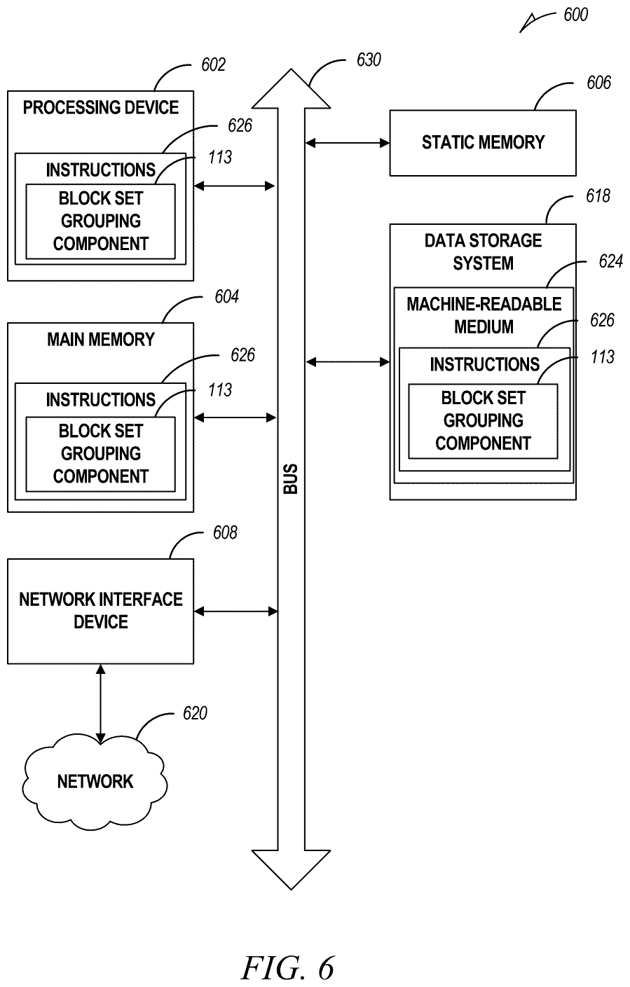

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block set grouping component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly executes a set (or multiple sets) of instructions to perform any one or more of the methodologies discussed herein.

The example computer system 600 includes a processing device 602, a main memory 604 (e.g., ROM, flash memory, DRAM such as SDRAM or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an ASIC, a FPGA, a digital signal processor (DSP), network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a block set grouping_component (e.g., the block set grouping component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A computing sub-system comprising:
a memory device comprising multiple planes, each plane comprising multiple blocks;
a processing device coupled to the memory device, the processing device to perform operations comprising:
identifying good blocks in each plane of the memory device; and
generating multiple block sets by grouping the good blocks, each block set comprising two blocks, the generating of the multiple block sets comprising generating a block set by grouping a first block from a first plane with a second block from a second plane.

2. The computing sub-system of claim 1, wherein the operations comprise:
generating multiple plane sets from the multiple planes, the generating of the multiple plane sets including generating a plane set by grouping the first plane with the second plane, wherein the grouping of the first block from the first plane with the second block from the second plane is based on the first plane and the second plane being included in the plane set.

3. The computing sub-system of claim 2, wherein the operations comprise:
generating a mapping of the multiple plane sets, the mapping identifying a pair of planes in each plane set; and
storing the mapping of the multiple plane sets.

4. The computing sub-system of claim 2, wherein the grouping of the first plane with the second plane is based on the first plane and the second plane being consecutive planes.

5. The computing sub-system of claim 4, wherein the grouping of the first block from the first plane with the second block from the second plane is based on the first block and the second block having the same physical block numbers within their respective planes.

6. The computing sub-system of claim 2, wherein the operations comprise:
determining a number of good blocks in each plane, wherein the grouping of the first plane with the second plane is based on the first plane and the second plane having a highest number of good blocks among the multiple planes.

7. The computing sub-system of claim 6, wherein the grouping of the first block from the first plane with the second block from the second plane is based on the first block and the second block having the same physical block numbers within their respective planes.

8. The computing sub-system of claim 1, wherein the operations comprise:
generating a mapping of the multiple block sets, the mapping identifying a pair of blocks in each block set; and
storing the mapping of the multiple block sets.

9. The computing sub-system of claim 1, wherein:
the first plane has a highest number of good blocks among the multiple planes of the memory device; and
the generating of the multiple block sets results in the first plane having one or more ungrouped blocks.

10. A method comprising:
identifying, by a processing device, good blocks in each plane of multiple planes of a memory device; and
generating, by the processing device, multiple block sets by grouping the good blocks, each block set comprising two blocks, the generating of the multiple block sets comprising generating a block set by grouping a first block from a first plane with a second block from a second plane.

11. The method of claim 10, comprising generating multiple plane sets from the multiple planes, the generating of the multiple plane sets including generating a plane set by grouping the first plane with the second plane, wherein the grouping of the first block from the first plane with the second block from the second plane is based on the first plane and the second plane being included in to the plane set.

12. The method of claim 11, comprising:
generating a mapping of the multiple plane sets, the mapping identifying a pair of planes in each plane set; and
storing the mapping of the multiple plane sets.

13. The method of claim 11, wherein the grouping of the first plane with the second plane is based on the first plane and the second plane being consecutive planes.

14. The method of claim 13, wherein the grouping of the first block from the first plane with the second block from the second plane is based on the first block and the second block having identical physical block numbers within their respective planes.

15. The method of claim 11, comprising determining a number of good blocks in each plane, wherein the grouping of the first plane with the second plane is based on the first plane and the second plane having a highest number of good blocks among the multiple planes.

16. The method of claim 15, wherein the grouping of the first block from the first plane with the second block from the second plane is based on the first block and the second block having identical physical block numbers within their respective planes.

17. The method of claim 10, comprising:
generating a mapping of the multiple block sets, the mapping identifying a pair of blocks in each block set; and
storing the mapping of the multiple block sets.

18. A computer-readable storage medium comprising instructions that, when executed by a processing device, configure the processing device to perform operations comprising:
identifying, by a processing device, good blocks in each plane of multiple planes of a memory device; and
generating, by the processing device, multiple block sets by grouping the good blocks, each block set comprising two blocks, the generating of the multiple block sets comprising generating a block set by grouping a first block from a first plane with a second block from a second plane.

19. The computer-readable storage medium of claim 18, wherein the operations comprise:
generating multiple plane sets from the multiple planes, the generating of the multiple plane sets including generating a plane set by grouping the first plane with the second plane, wherein the grouping of the first block from the first plane with the second block from the second plane is based on the first plane and the second plane being included to the plane set.

20. The computer-readable storage medium of claim 18, wherein the operations comprise:
determining a number of good blocks in each plane, wherein the grouping of the first plane with the second plane is based on the first plane and the second plane having a highest number of good blocks among the multiple planes, wherein the grouping of the first block from the first plane with the second block from the second plane is based on the first block and the second block having identical physical block numbers within their respective planes.
